(19) United States
(12) Patent Application Publication
(10) Pub. No.: US 2024/0366349 A1
(43) Pub. Date: Nov. 7, 2024

(54) DENTAL FLOSS PRODUCT PACKAGING AND DISPENSING APPARATUS, SYSTEM AND METHOD

(71) Applicant: 5W Consulting, LLC, Elverson, PA (US)

(72) Inventor: Benjamin D. Lustig, Elverson, PA (US)

(21) Appl. No.: 18/653,854

(22) Filed: May 2, 2024

Related U.S. Application Data
(60) Provisional application No. 63/463,547, filed on May 2, 2023.

(51) Int. Cl. A61C 15/04

(52) U.S. Cl. CPC A61C 15/043

(57) ABSTRACT

An apparatus, system, process, and method for producing a dental floss dispenser is disclosed. In one embodiment the dental floss dispenser comprises a refillable dental floss case having internal surfaces forming a bobbin cavity, and a flanged bobbin preloaded with dental floss, wherein the preloaded dental floss flanged bobbin is in rotatable contact with one or more of the internal surfaces of the bobbin cavity, such that the dental floss may be freely dispensed from the dental floss dispenser. Such a dental floss dispenser provides a more economical and sustainable value proposition to the dental floss market as compared to conventional disposable, single use dental floss dispensers.

### FIELD OF THE DISCLOSURE

The present embodiments are generally directed to the packaging and dispensing of products. In certain embodiments, the disclosure is directed to refillable, reusable, and/or environmentally friendly packaging and/or dispensers, including but not limited to the packaging and/or dispensing of dental floss. The embodiments further disclose systems, methods and/or apparatus for assembling dispensers and/or packaging such as packaging, dispensers, and/or dispensing of dental floss and/or the manner for using such packaging and/or dispensers.

### BACKGROUND

The efficient and cost-effective packaging and dispensing of dental floss and other products has long been challenging from both the manufacturing and user perspectives. In particular, dental floss is an inherently difficult material to handle and package in the manufacturing environment, as well as difficult to effectively and efficiently dispense from the product packaging by the end user. In this regard, dental floss may comprise many different and varying materials which may make the efficient packaging of the floss difficult, particularly in an automated manufacturing environment. Moreover, if not packaged properly, the floss may be difficult to dispense from the packaging by the end user.

Present dental floss dispensers and/or product packaging are made from environmentally unfriendly and/or non-recyclable materials. Such dispensers and/or product packaging are typically single use dispensers and/or packaging and are completely disposed of upon depletion of the dental floss. Such present dispensers and/or product packaging also may not lend themselves to the efficient and/or effective floss dispensing by the end user.

Accordingly, there exists a need for an apparatus and method for the efficient, refillable, reusable, and/or cost-effective dispenser and/or product packaging of or used in connection with the distribution of dental floss. There is also the desire to manufacture dental floss dispensers and/or packaging with reusable and/or from sustainable or environmentally friendly materials.

### SUMMARY OF THE DISCLOSURE

The present disclosure relates to apparatus, systems, processes, and methods for producing, and using a refillable and/or reusable dental floss dispenser, and product packaging associated with the distribution thereof.

In one embodiment, the disclosure relates to apparatus, systems, processes, and methods for producing a dental floss dispenser. In one embodiment the dental floss dispenser comprises a refillable dental floss case having internal surfaces forming a bobbin cavity, and a flanged bobbin preloaded with dental floss, wherein the preloaded dental floss flanged bobbin is in rotatable contact with one or more of the internal surfaces of the bobbin cavity, such that the dental floss may be freely dispensed from the dental floss dispenser. Such a dental floss dispenser provides a more economical and sustainable value proposition to the dental floss market as compared to conventional disposable, single use dental floss dispensers.

In yet another embodiment, the disclosure relates to a dental floss dispenser comprising a refillable dental floss case having internal surfaces forming a bobbin cavity, and a flanged bobbin containing dental floss, wherein the dental floss flanged bobbin is in rotatable contact with one or more of the internal surfaces of the bobbin cavity, such that the dental floss may be freely dispensed from the dental floss dispenser.

In another embodiment, the disclosure relates to a dental floss refill bobbin comprising a quill portion having opposed ends, and opposing flange portions positioned at each opposed end of the quill, and each flange portion having interior and exterior surfaces, and dental floss having an end portion, the dental floss positioned on the quill.

In yet another embodiment, the disclosure relates to a process for filling a dental floss dispenser with dental floss comprising the steps of: releasing from a hinge retaining clip of a refillable dental floss case a retractable hinge portion of the dental floss case hingedly attached to said dental floss case, the retractable hinge portion having an open position and a closed position, and the dental floss case having one or more internal surfaces forming a bobbin cavity; positioning the hinge retaining portion of the dental floss case in the open position to allow access to the bobbin cavity; inserting into the bobbin cavity a flanged bobbin preloaded with dental floss, the dental floss having a free end, the flanged bobbin being in rotatable contact with one or more of the internal surfaces of the bobbin cavity; positioning the hinge retaining portion of the dental floss case in the closed position; the placing the free end of the dental floss into a dispensing position.

In certain embodiments, the refillable dental floss case and/or flanged bobbin of this disclosure may present a more sustainable value proposition to the dental floss market as compared to disposable dental floss retail sellable units presently known.

In other embodiments, processes for making and/or assembling refillable and/or reusable dental floss dispenser, and product packaging associated with the distribution thereof.

### BRIEF DESCRIPTION OF THE DRAWINGS

The accompanying drawings, diagrams, figures and/or Appendices, which are included to provide a further understanding of the invention and are incorporated in and constitute a part of this specification, illustrate embodiments of the invention and together with the description serve to explain the principles of the invention, in which like numerals refer to like components or steps, and wherein:

FIG. 1 is a perspective view of a dental floss dispenser with the floss case lid in a closed position.

FIG. 2 is a front elevation view of the dental floss dispenser of FIG. 1.

FIG. 3 is a top plan view of the dental floss dispenser of FIG. 1.

FIG. 4 is a side elevation view of the dental floss dispenser of FIG. 1.

FIG. 5 is a front elevation sectional view of the dental floss dispenser of FIG. 1.

FIG. 6 is a perspective view of the dental floss dispenser of FIG. 1 with the floss case lid and the retractable hinge portion in open positions without a floss bobbin installed.

FIG. 7 is a perspective view of the dental floss dispenser of FIG. 1, with the floss case lid and the retractable hinge portion in open positions, depicting an installation process of a floss bobbin.

FIG. 8 is a perspective view of the dental floss dispenser of FIG. 1 with the floss case lid and the retractable hinge portion in open positions with a floss bobbin installed.

FIG. 9 is a perspective view of the dental floss dispenser of FIG. 1 with the floss case lid in an open position and the retractable hinge portion in closed positions with a floss bobbin installed.

FIG. 10 is a side elevation sectional view of the dental floss dispenser depicting section 10-10 shown in FIG. 2.

FIG. 11 is a top plan view of the dental floss dispenser of FIG. 1 with the floss case lid and the retractable hinge portion in open positions without a floss bobbin installed.

FIG. 12 is a perspective view of a floss bobbin in an upright position.

FIG. 13 is an additional perspective view of the floss bobbin of FIG. 12 in an upright position.

FIG. 14 is a front elevation view of the floss bobbin of FIG. 12 in an upright position.

FIG. 15 is a top plan view of the floss bobbin of FIG. 12.

FIG. 16 is a top plan sectional view of the floss bobbin of FIG. 12 depicting section 16-16 shown in FIG. 14.

FIG. 17 is an exploded perspective view of the floss bobbin of FIG. 12.

FIG. 18 is a perspective view of the floss bobbin of FIG. 12 having a shrink band.

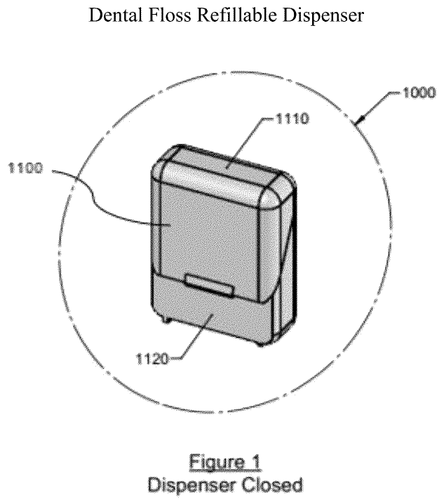

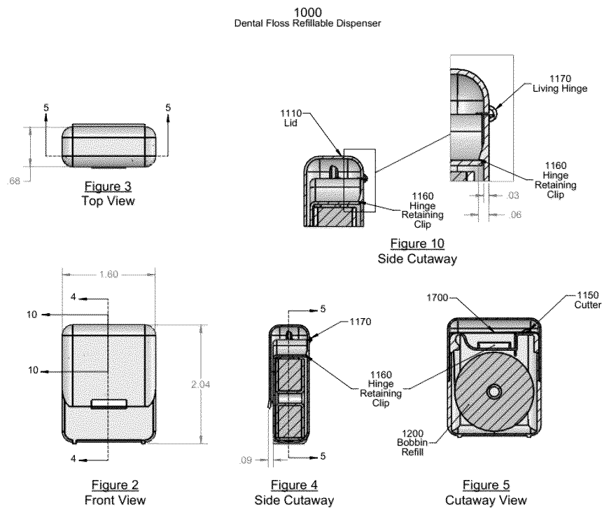

APPENDIX A discloses additional features of the dental floss dispenser.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in a typical dental floss dispensing system. Those of ordinary skill in the pertinent art may recognize that other elements may be desirable and/or required in order to implement the present invention. However, because such elements are well known in the art, and because they do not facilitate a better understanding of the present invention, a discussion of such elements is not provided herein.

Reference will now be made in detail to several exemplary and non-limiting embodiments of the present invention, some of which are illustrated in the accompanying drawings.

The present disclosure relates to apparatus, systems, processes, and methods for producing, and using a refillable and/or reusable dental floss dispenser, and product packaging associated with the distribution thereof.

In certain embodiments the refillable dental floss dispenser comprises a dental floss case 1100 having a flanged bobbin 1200 therein. In certain embodiments, dental floss case 1100 may be comprised of a molded floss case 1100 and a metal cutter attachment 1150 along with a flanged bobbin 1200 having a quill 1230 between two flanges 1210 and 1220, and a fiber or yarn to be used for the flossing of teeth wound around quill 1230 of flanged bobbin 1200.

In certain embodiments refillable dental floss case 1100 may store floss bobbin 1200 and may facilitate the dispensing and cutting of a floss fiber or yarn strand 1700 from flanged bobbin 1200 by a user via a metal cutter 1150 that is mechanically fastened to case 1100.

In certain embodiments refillable dental floss case 1100 may comprise a single or multiple component injection molded part or parts with a polypropylene or other suitable resin.

In certain embodiments refillable dental floss case 1100 may comprise two living hinges 1170 and 1180. A first living hinge 1170 may be located on the back side of dental floss case 1100 which connects or joins a dental floss case lid portion 1110 to a main body portion 1120 of dental floss case 1100. Among other functions, lid portion 1110 may serve to protect dental floss 1700 of a fully assembled dental floss dispenser 1000 from contamination during storage of dental floss dispenser 1000, as well as in between uses of dental floss dispenser 1000. In certain embodiments, lid portion 1110 may snap closed as lid portion 1110 engages with case main body portion 1120 via interference of raised attributes or portions 1175 and 1185 located both on the inside of lid portion 1110 and on each side of case body portion 1120.

In certain embodiments a second living hinge 1180 may be located on the front side of dental floss case 1120 which connects or joins a ‘retractable hinge’ component or portion 1130 of case 1120 to the case main body portion 1120. Retractable hinge portion 1130 may be designed to be secured to dental floss case body 1120 under a hinge retaining clip 1160 located on the inside of case body 1120 when dental floss dispenser 1000 is assembled and subsequently loaded with bobbin 1200 and threaded with floss 1700. Retractable hinge portion 1130 may also be designed to be easily opened by a user when an empty bobbin 1200 is to be removed from case 1120 and replaced with a new bobbin refill 1800. In certain embodiments, refill bobbins 1800 may be replaced in dental floss dispenser 1000 without the use of tools.

In certain embodiments flanged bobbin 1200 may comprise flanges 1210 and 1220 adjacent to each end of bobbin quill 1210. In certain embodiments, flanged bobbin 1200 may be wound with dental floss 1700, refill bobbin 1800 being inserted into body 1120 of the dental floss case 1100, and dental floss 1700 being threaded in dental floss dispenser 1000 such that dental floss 1700 may be unwound from refill bobbin 1800 as the user dispenses floss 1700 from dental floss dispenser 1000.

Turning now to FIG. 18, in certain embodiments flanged bobbin 1200 may be wound with dental floss 1700 to form refill bobbin 1800. Refill bobbin 1800 may then be wrapped in heat shrink band 1810 or other suitable protective material and to enable the refill bobbin 1800, wound with dental floss 1700 and wrapped in heat shrink band 1810, to be packaged into a carton, blistered package or other suitable packaging.

In certain embodiments, the design of flanged bobbin 1200 may provide a manufacturer with the flexibility to choose from a wide range of materials of construction given the structural integrity offered by the design of flanged bobbin 1200. Such materials may include, for example, biodegradable dry molded cellulose fiber, thermoplastic starch-based plastic, high density polyethylene (HDPE), and other thermoplastic polymers used in injection molding processes. Alternatively, flanged bobbin 1200 may be constructed of paper or similar materials.

In certain embodiments, the wall thicknesses of bobbin flanges 1210 and 1220 and bobbin quill 1230 may be approximately 0.040″ as shown in FIGS. 15 and 16 of the drawings. Such dimensions generally reflect a thickness appropriate for an injection molded bobbin 1200 made of a thermoplastic polymer such as HDPE. However, such thickness may vary based on the material of construction as determined by the manufacturer.

In certain embodiments, the inner diameter of bobbin quill 1230, as shown FIG. 14 is approximately 0.175″, but can be adjusted to accommodate interfaces of the machine designed to wind quill 1230 with floss.

Turning now to FIG. 16, flanged bobbin 1200's inner diameter of flanges 1210 and/or 1220 and/or quill 1230 may be is designed with approximately a 45° lead-in to aid in centering flanged bobbin 1200 during the process of winding dental floss 1700 around quill 1230.

In certain embodiments, heat shrink bands 1810 may be a sourced component. There may be many suitable options of heat shrink bands 1810 available, including, but not limited to, those made of polyethylene terephthalate glycol (PETG). Generally, PETG is a thermoplastic with excellent formability and serves as an exceptional food-grade packaging material. Heat shrink bands 1810 made of cellulose also may provide a biodegradable alternative.

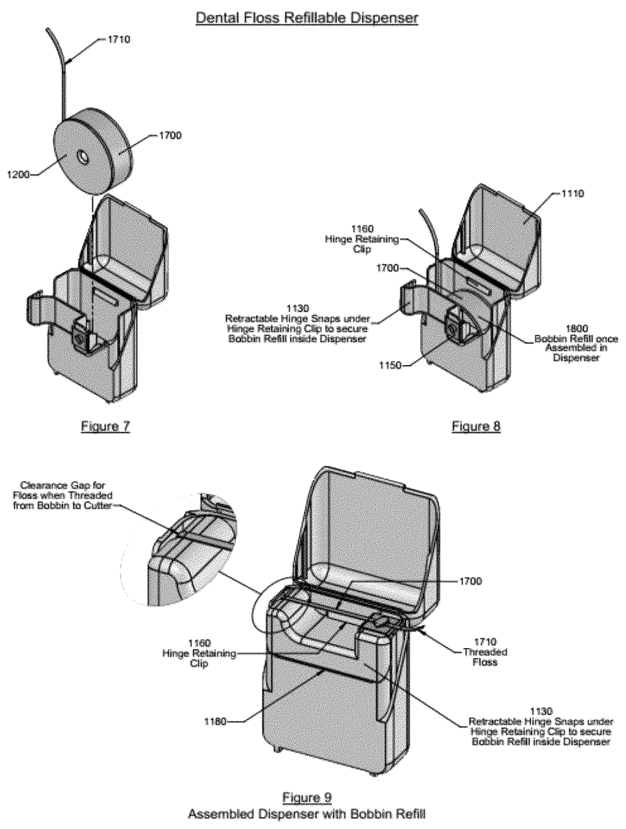

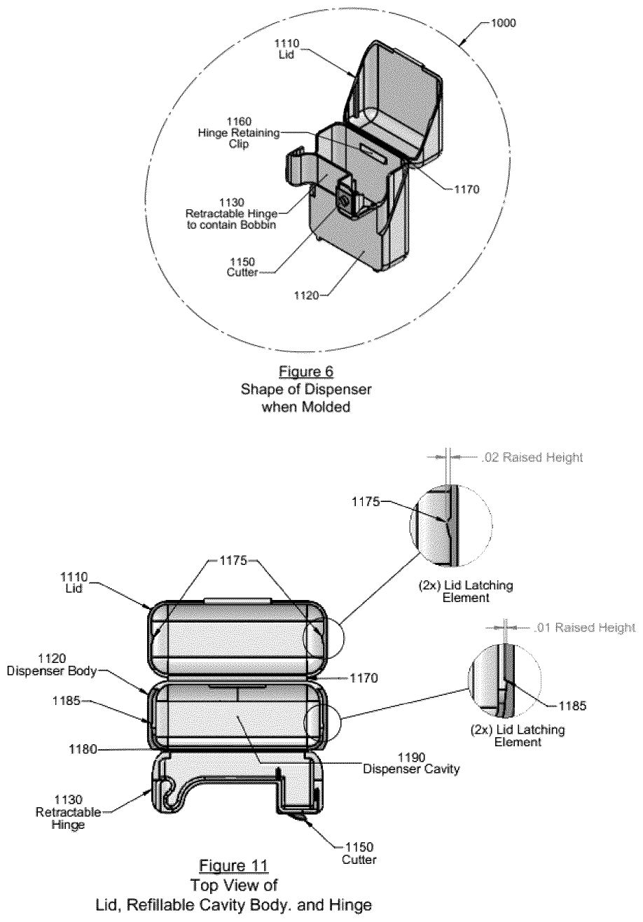

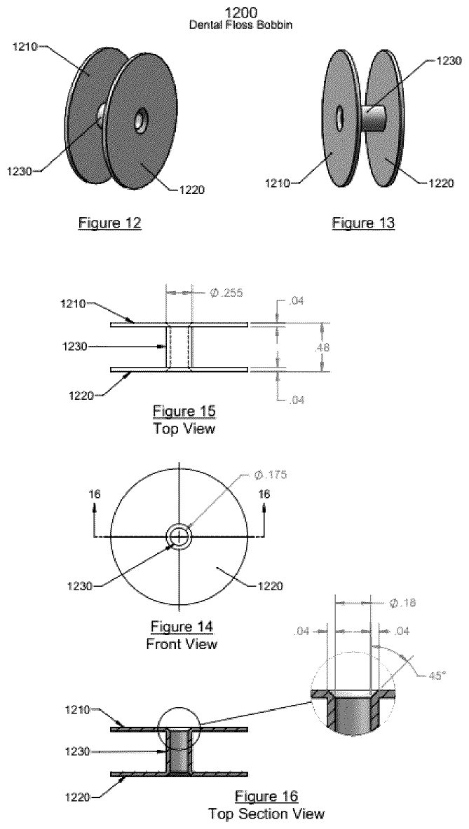

Turning now to FIGS. 7, 8, 9 and 11, a “single cavity” design 1190 of dental floss case 1100 may provide a quick and easy bobbin 1200 replacement procedure (as shown in FIGS. 7, 8, and 9), as compared to floss cases that have a clamshell shape when molded and the case body is formed by fastening the front and back halves together.

In certain embodiments of manufacturing refill bobbins 1800, the starting end of floss 1700 may be tucked into floss package 1800, comprising floss 1700 wound around quill 1230, resulting in a clearer, professional look and eliminating a material attribute that may present a challenge during product manufacturing or user usage of dispenser 1000.

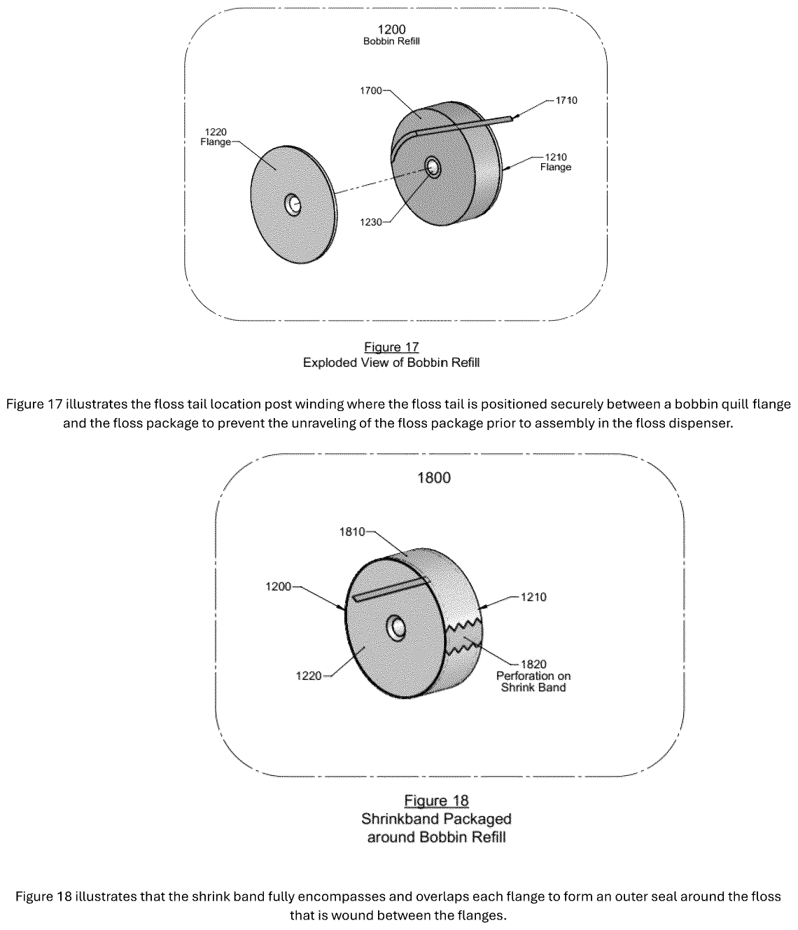

Turning now to FIGS. 17 and 18, tail end 1710 of floss 1700 may be tucked into the wound floss package during the floss winding process around quill 1230. In certain embodiments, floss 1700 may be wound around quill 1230 at a width slightly less than the width gap between flanges 1210 and 1220 of bobbin 1200 forming a gap width of approximately 0.40″ as shown in FIGS. 17 and 18. In certain embodiments, refill floss package 1800 comprising floss 1700 wound around quill 1230 may also be wound around quill 1230 slightly off-center between flanges 1210 and 1220 to allow floss tail 1710 to be tucked in a gap formed between wound floss package and one of flanges 1210 or 1220. In certain embodiments, flanged bobbin 1200 may eliminate the risk of floss 1700 unraveling during processing, storage, and handling for many if not all floss 1700 fiber types designed for flossing. Furthermore, certain embodiments of the design of flanged bobbin 1200 may also eliminate the need for process aids such as application to floss 1700 of, for example, beeswax, mint coatings, and the like to prevent the unraveling of floss 1700 during the winding process around quill 1230.

In certain embodiments, shrink band 1810 comprising thermoplastic material is one of the easiest materials available to recycle and is generally accepted at most recycling facilities in the United States.

In certain embodiments, shrink band 1810 allows flanged bobbin 1200 to be packaged directly in a retail carton or blister pack without the need for additional packaging to protect floss 1700 from contamination.

In certain embodiments, case lid 1110 and front retractable hinge portion 1130 are in an “open” position when case 1100 is molded, thus reducing or eliminating any preassembly requirements in order to insert bobbin 1200 or refill bobbin 1800 into case cavity 1190.

In certain embodiments, bobbin 1200 floss 1700 length range may be approximately between about 4 meters to about 60 meters of floss given a flanged diameter of about 1.35 inches. Other floss 1700 lengths are also contemplated. Generally, in certain embodiments, bobbin 1200 floss 1700 length range may be dependent upon the particular floss 1700 fiber denier and cross-sectional shape.

In certain embodiments, dental floss dispenser 1000 offers more sustainable product offerings versus disposable floss products made of plastic.

In certain embodiments, dental floss dispenser 1000 provides a substantially unitary construction of dental floss case 1100 product packaging and flanged bobbin 1200. Such designs provide enhanced manufacturability including but not limited to consistent part manufacture and reduces or eliminates risks associated with machine and/or product contamination from process aids, wax, mint coatings, and the like which are applied to floss 1700.

In certain embodiments, dental floss dispenser 1000 provides component complexity reduction in that dispenser 1000 offers constructions which comprise substantially universal components for all Skus including but not limited to case 1100, flanged bobbin 1200, and cutter 1150.

In certain embodiments, dental floss dispenser 1000 may provide professional and retail design standardization by converting a customer's professional SKU(s) to dental floss refillable dispensing consumer unit 1000 reduces SKU complexity.

In certain embodiments, dental floss dispenser 1000 may provide a more effective marketing vehicle in that consumers receiving a refillable dental floss dispenser 1000 from their dental professional may be provided with a product that incentivizes purchase given a lower transaction size bobbin refill 1800 product offering.

APPENDIX A discloses additional features of dental floss dispenser 1000.

The disclosure herein is directed to the variations and modifications of the elements and methods of the invention disclosed that will be apparent to those skilled in the art in light of the disclosure herein. Thus, it is intended that the present invention covers not only the embodiments which are disclosed herein but also all modifications and variations of those embodiments and all equivalents thereof.

1. A dental floss dispenser comprising:
a refillable dental floss case having internal surfaces forming a bobbin cavity; and
a flanged bobbin containing dental floss;
wherein said dental floss flanged bobbin is in rotatable contact with one or more of said internal surfaces of said bobbin cavity, such that said dental floss may be freely dispensed from said dental floss dispenser.

2. The dental floss dispenser of claim 1, wherein said refillable dental floss case comprises:
a case body; and
a case lid hingedly attached to said case body;
wherein said case lid has an open position and a closed position.

3. The dental floss dispenser of claim 1, said refillable dental floss case further comprises:
a retractable hinge portion; and
a hinge retaining clip, wherein said retractable hinge portion releasably engages said hinge retaining clip to allow access to said bobbin cavity.

4. The dental floss dispenser of claim 1, wherein said refillable dental floss case is of unitary construction.

5. The dental floss dispenser of claim 1, wherein said flanged bobbin comprises a quill portion between two flanged portions, said quill portion having a cavity therethrough, and said quill cavity having an interior surface.

6. The dental floss dispenser of claim 1, wherein said dental floss case is not in contact with said interior surface of said quill cavity.

7. The dental floss dispenser of claim 3, wherein said retractable hinge portion comprises a cutter for detaching a length of said dental floss dispensed from said flanged bobbin.

8. The dental floss dispenser of claim 3, said retractable hinge portion having a floss clearance gap therein.

9. A dental floss refill bobbin comprising:
a quill portion having opposed ends; and
opposing flange portions positioned at each opposed end of said quill, and each flange portion having interior and exterior surfaces; and
dental floss having an end portion, said dental floss positioned on said quill.

10. The dental floss refill bobbin of claim 9, wherein at least a portion of said dental floss is positioned on said quill and not in contact with at least one of said interior surfaces of said opposing flanges to form a gap between said dental floss and said interior surface of at least one of said opposing flanges, and wherein said free end of said floss is positioned in said gap to substantially prevent said floss from unravelling from said quill.

11. The dental floss refill bobbin of claim 9, wherein said dental floss is substantially wrapped in heat activated shrink wrap material to substantially deter contamination of said dental floss.

12. The dental floss refill bobbin of claim 9, said quill portion having a cavity therethrough, and said quill cavity having an interior surface.

13. The dental floss refill bobbin of claim 9, wherein when said dental floss refill bobbin is positioned in a dental floss dispenser comprising a dental floss case, said interior surface of said quill cavity is not in contact with dental floss case.

14. A process for filling a dental floss dispenser with dental floss comprising the steps of:
releasing from a hinge retaining clip of a refillable dental floss case a retractable hinge portion of said dental floss case hingedly attached to said dental floss case, said retractable hinge portion having an open position and a closed position, and said dental floss case having one or more internal surfaces forming a bobbin cavity;
positioning said hinge retaining portion of said dental floss case in said open position to allow access to said bobbin cavity;
inserting into said bobbin cavity a flanged bobbin preloaded with dental floss, said dental floss having a free end, said flanged bobbin being in rotatable contact with one or more of said internal surfaces of said bobbin cavity;
positioning said hinge retaining portion of said dental floss case in said closed position; and
positioning said free end of said dental floss into a dispensing position.

15. The process for filling a dental floss dispenser with dental floss of claim 14, wherein said dental floss case comprises:
a case body; and
a case lid hingedly attached to said case body;
wherein said case lid has an open position and a closed position.

16. The process of claim 14, wherein said step of positioning said free end of said dental floss into said dispensing position comprises the step of threading said free end of said dental floss through said hinge retaining portion of said dental floss case having a floss clearance gap therein.

17. The process of claim 16, wherein said step of positioning said free end of said dental floss into said dispensing position further comprises the step of threading said free end of said dental floss through said floss clearance gap.

18. The process of claim 14, wherein said step of positioning said free end of said dental floss into said dispensing position comprises the step of threading said free end of said dental floss through a cutter for detaching a length of said dental floss dispensed from said flanged bobbin.

19. The process of claim 14, further comprising the step of detaching a length of said dental floss dispensed from said flanged bobbin.

20. The process of claim 18, further comprising the step of detaching a length of said dental floss dispensed from said flanged bobbin using said cutter.
